(19) United States
(12) Patent Application Publication
(10) Pub. No.: US 2026/0029670 A1
(43) Pub. Date: Jan. 29, 2026

(54) OPTICAL MODULATOR INTEGRATED LASER ELEMENT, OPTICAL MODULATION CIRCUIT, AND OPTICAL MODULATOR

(71) Applicant: Sumitomo Electric Device Innovations, Inc., Yokohama-shi (JP)

(72) Inventor: Hiroshi HARA, Kanagawa (JP)

(73) Assignee: Sumitomo Electric Device Innovations, Inc., Yokohama-shi (JP)

(21) Appl. No.: 19/276,193

(22) Filed: Jul. 22, 2025

(30) Foreign Application Priority Data
Jul. 24, 2024 (JP) 2024-118943

(51) Int. Cl. G02F 1/025

(52) U.S. Cl. CPC G02F 1/025

(57) ABSTRACT

An optical modulator integrated laser element includes a laser unit configured to output laser light, an optical modulator that includes a modulation electrode to which one differential signal is input as a positive-phase signal, and a dummy element unit to which another differential signal is input as a negative-phase signal. The optical modulator is connected between the one differential signal and a reference potential. The dummy element unit is connected between the another differential signal and the reference potential, and includes a resistive component and a capacitive component connected in parallel.

### CROSS REFERENCE TO RELATED APPLICATIONS

This application is based upon and claims the benefit of priority from Japanese Patent Application No. 2024-118943, filed Jul. 24, 2024; the entire contents of which are incorporated herein by reference.

### TECHNICAL FIELD

The present disclosure relates to an optical modulator integrated laser element, an optical modulation circuit, and an optical modulator.

### BACKGROUND

Japanese Unexamined Patent Publication No. 2001-308130 discloses a high-frequency circuit. In the high-frequency circuit, a signal line for transmitting a high-frequency signal and a capacitive element are connected by a first bonding wire, and the capacitive element and a termination resistor for impedance matching are connected by a second bonding wire. Japanese Unexamined Patent Publication No. 2004-061556 discloses a driving circuit and a driving method of a semiconductor laser module including an electro-absorption optical modulator.

### SUMMARY

An optical modulator integrated laser element according to an embodiment of the present disclosure includes: a laser unit configured to output laser light; an optical modulator that includes a modulation electrode to which one differential signal is input as a positive-phase signal; and a dummy element unit to which another differential signal is input as a negative-phase signal. The optical modulator is connected between the one differential signal and a reference potential. The dummy element unit is connected between the another differential signal and the reference potential, and includes a resistive component and a capacitive component connected in parallel.

### BRIEF DESCRIPTION OF THE DRAWINGS

FIG. 1 is a circuit diagram illustrating a configuration of an optical modulator integrated laser element according to an embodiment of the present disclosure.

FIG. 2 is a perspective view illustrating an external appearance of the optical modulator integrated laser element.

FIG. 3 is a view illustrating a cross-section passing through a second signal pad, a resistor, an electrode, and a modulation electrode shown in FIG. 2.

FIG. 4 is a view illustrating a cross-section along line IV-IV shown in FIG. 2.

FIG. 5 is a view illustrating a cross-section along line V-V shown in FIG. 2.

FIG. 6 is a view illustrating a cross-section along line VI-VI shown in FIG. 2.

FIG. 7 is a view illustrating a cross-section along line VII-VII shown in FIG. 2.

FIG. 8 is a view illustrating a cross-section along line VIII-VIII shown in FIG. 2.

FIG. 9 is a perspective view illustrating an optical modulation circuit.

FIG. 10 is a plan view illustrating the optical modulation circuit.

FIG. 11 is a circuit diagram when a dummy element unit is provided away from a semiconductor substrate.

FIG. 12A is a circuit diagram of the optical modulator integrated laser element.

FIG. 12B is a circuit diagram of the optical modulator integrated laser element.

FIG. 13A is a graph illustrating a relationship between a frequency and Sdd11.

FIG. 13B is a graph illustrating a relationship between a frequency and Sdd11.

FIG. 14A is a graph illustrating a relationship between the frequency and the Sdd11.

FIG. 14B is a graph illustrating a relationship between the frequency and the Sdd11.

FIG. 15 is a table showing an example of a combination of impedance of an optical modulator and impedance of the dummy element unit.

FIG. 16 is a graph illustrating a relationship between a value of a ratio of the impedance of the optical modulator and the impedance of the dummy element unit, and a reflection coefficient at 1 GHz.

FIG. 17 is a circuit diagram illustrating a configuration of a modification.

### DETAILED DESCRIPTION

In an optical modulator integrated laser element in the related art in which a semiconductor laser and an electro-absorption optical modulator are integrated, reflection of a high-frequency signal occurs due to load impedance (for example, 33Ω) different from characteristic impedance (for example, 50Ω) of a transmission line for transmitting a high-frequency signal that is supplied to the optical modulator. Since the reflection of the high-frequency signal leads to a signal loss, it is preferable to reduce the reflection. The reflection of the high-frequency signal can be reduced by making the load impedance close to the characteristic impedance. However, in this case, a band of the high-frequency signal is narrowed, and thus it is difficult to sufficiently secure the band of the high-frequency signal. In this manner, in the optical modulator integrated laser element in the related art, it is difficult to avoid trade-off between the reflection of the high-frequency signal and the securement of the band.

An object of the present disclosure is to provide an optical modulator integrated laser element, an optical modulation circuit, and an optical modulator which are capable of avoiding narrowing of the band of the high-frequency signal while reducing reflection of the high-frequency signal.

According to the present disclosure, it is possible to provide an optical modulator integrated laser element, an optical modulation circuit, and an optical modulator which are capable of avoiding narrowing of the band of the high-frequency signal while reducing reflection of the high-frequency signal.

### Embodiment of Present Disclosure

First, the contents of the embodiment of the present disclosure will be listed and described.

[1] An optical modulator integrated laser element according to the embodiment of the present disclosure includes: a laser unit configured to output laser light; an optical modulator that includes a modulation electrode to which one differential signal is input as a positive-phase signal; and a dummy element unit to which another differential signal is input as a negative-phase signal. The optical modulator is connected between the one differential signal and a reference potential. The dummy element unit is connected between the another differential signal and the reference potential, and includes a resistive component and a capacitive component connected in parallel. In the optical modulator integrated laser element, the another differential signal is input to the dummy element unit. According to this, load impedance of a circuit including the optical modulator to which the one differential signal is input as a positive-phase signal and a termination resistor, and load impedance of the dummy element unit to which the another differential signal is input as a negative-phase signal are composed, and the overall load impedance can be made to be close to characteristic impedance of a transmission line. Accordingly, reflection of a high-frequency signal can be reduced. In addition, a band of the high-frequency signal can also be secured to have the same width as in an optical modulator in the related art. Accordingly, according to the optical modulator integrated laser element of [1], it is possible to avoid narrowing of the band of the high-frequency signal while reducing reflection of the high-frequency signal, and it is possible to improve trade-off between the reflection of the high-frequency signal and the securement of the band.

[2] In the optical modulator integrated laser element according to [1], the capacitive component of the dummy element unit may be a capacitor element having a configuration in which a dielectric substance is sandwiched between a pair of electrodes. For example, according to this configuration, it is possible to obtain the capacitive component of the dummy element unit.

[3] In the optical modulator integrated laser element according to [1], the capacitive component of the dummy element unit may include a region having the same semiconductor lamination structure as the optical modulator connected to both ends of the capacitive component. For example, according to this configuration, it is possible to obtain the capacitive component of the dummy element unit.

[4] In the optical modulator integrated laser element according to any one of [1] to [3], impedance Zp of the optical modulator and impedance Zn of the dummy element unit may satisfy a relationship of 1≤(Zn/Zp)≤3. In this case, it is possible to further reduce the reflection of the high-frequency signal.

[5] An optical modulation circuit according to the embodiment of the present disclosure includes: a pair of transmission lines through which differential signals are transmitted; an optical modulator to which one differential signal of the differential signals is input as a positive-phase signal; and a dummy element unit to which another differential signal of the differential signals is input as a negative-phase signal. The optical modulator is connected between one of the transmission lines and a reference potential. The dummy element unit is connected between the another differential signal and the reference potential, and includes a resistive component and a capacitive component connected in parallel. According to the optical modulator integrated laser element, it is possible to avoid narrowing of the band of the high-frequency signals while reducing reflection of the high-frequency signal, and it is possible to improve trade-off between the reflection of the high-frequency signals and the securement of the band.

[6] In the optical modulation circuit according to [5], the capacitive component of the dummy element unit may be a capacitor element having a configuration in which a dielectric substance is sandwiched between a pair of electrodes. For example, according to this configuration, it is possible to obtain the capacitive component of the dummy element unit.

[7] In the optical modulation circuit according to [5], the capacitive component of the dummy element unit may include a region having the same semiconductor lamination structure as in the optical modulator connected to both ends of the capacitive component. For example, according to this configuration, it is possible to obtain the capacitive component of the dummy element unit.

[8] In the optical modulation circuit according to any one of [5] to [7], impedance Zp of the optical modulator and impedance Zn of the dummy element unit may satisfy a relationship of 1≤(Zn/Zp)≤3. In this case, it is possible to further reduce the reflection of the high-frequency signal.

[9] An optical modulator according to the embodiment of the present disclosure includes: an optical modulator including a modulation electrode to which one differential signal is input as a positive-phase signal; and a dummy element unit to which another differential signal is input as a negative-phase signal. The optical modulator is connected between the one differential signal and a reference potential. The dummy element unit is connected between the another differential signal and the reference potential, and includes a resistive component and a capacitive component connected in parallel.

[10] In the optical modulator according to [9], the capacitive component of the dummy element unit may be a capacitor element having a configuration in which a dielectric substance is sandwiched between a pair of electrodes. For example, according to this configuration, it is possible to obtain the capacitive component of the dummy element unit.

[11] In the optical modulator according to [9], the capacitive component of the dummy element unit may include a region having the same semiconductor lamination structure as the optical modulator connected to both ends of the capacitive component. For example, according to this configuration, it is possible to obtain the capacitive component of the dummy element unit.

[12] In the optical modulator according to any one of [9] to [11], impedance Zp of the optical modulator and impedance Zn of the dummy element unit may satisfy a relationship of 1≤(Zn/Zp)≤3. In this case, it is possible to further reduce the reflection of the high-frequency signal.

### DETAILS OF EMBODIMENTS OF PRESENT DISCLOSURE

Specific examples of the present disclosure will be described below with reference to the accompanying drawings. The present disclosure is not limited to the examples, and is intended to include all modifications within meaning and scope equivalent to the appended claims. In the following description, the same reference numeral will be given to the same element, and redundant description thereof will be omitted.

### First Embodiment

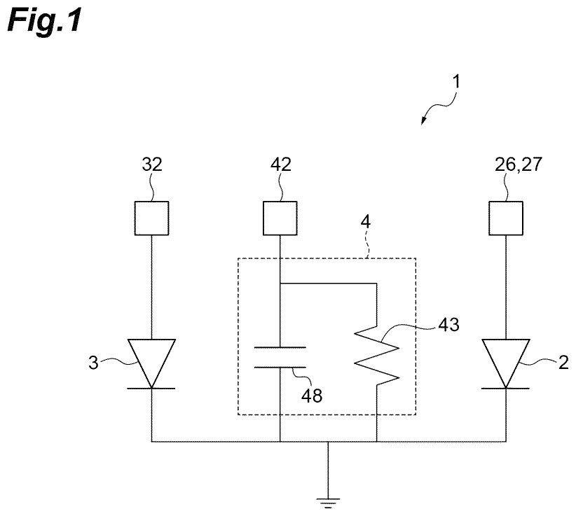

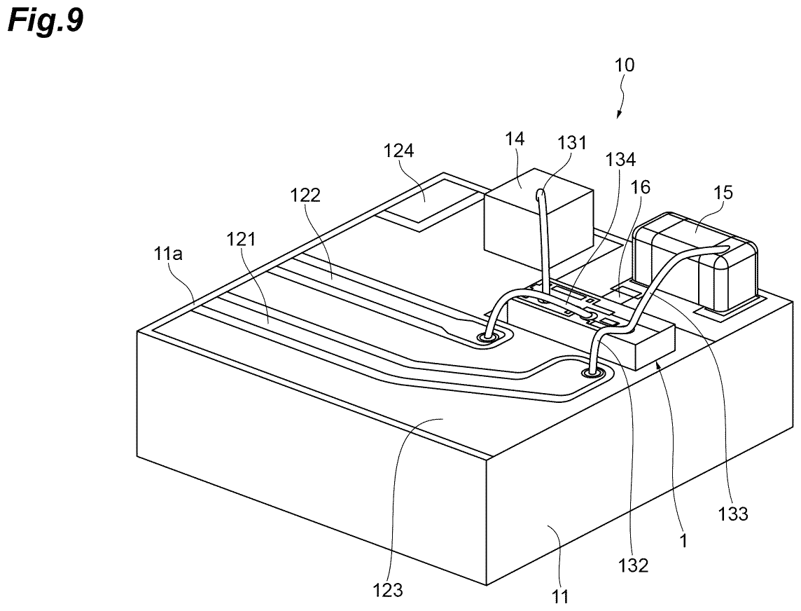

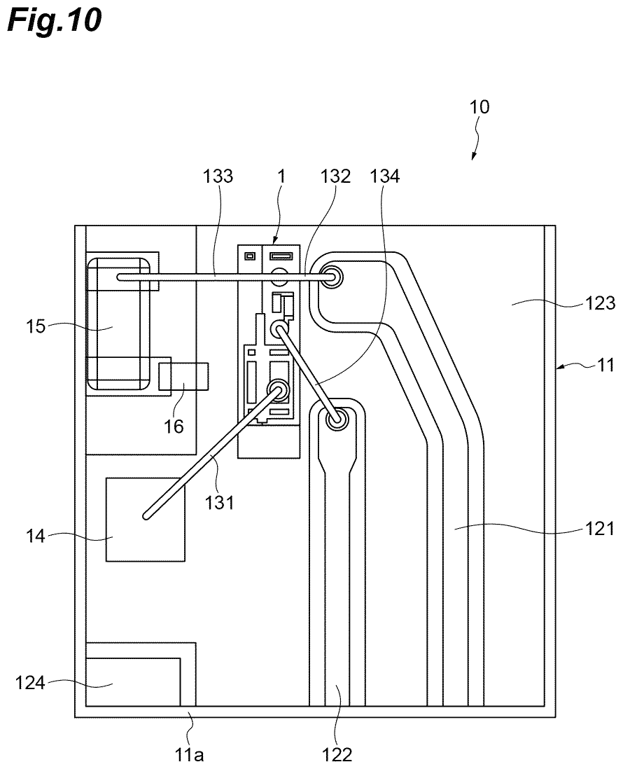

FIG. 1 is a circuit diagram illustrating a configuration of an optical modulator integrated laser element (electro-absorption modulator integrated laser diode (EML)) 1 according to an embodiment of the present disclosure. The EML 1 of this embodiment includes a laser unit 2 that outputs laser light, an optical modulator 3 that modulates the laser light, and a dummy element unit 4 that simulates characteristics of the optical modulator. A pad 26 and a pad 27 are connected to an anode of the laser unit 2. A first signal pad 32 is connected to an anode of the optical modulator 3. A second signal pad 42 is connected to a first end of the dummy element unit 4. A cathode of the laser unit 2, a cathode of the optical modulator 3, and a second end of the dummy element unit 4 are electrically connected to each other, and are set to a reference potential. A termination resistor 16 (refer to FIG. 9 and FIG. 10) is connected to the optical modulator 3 in parallel. The dummy element unit 4 of this embodiment includes a resistor 43 and a capacitor 48 connected to each other in parallel. The resistor 43 is a resistive component in the present disclosure. The capacitor 48 is a capacitive component in the present disclosure. Impedance Zp of the optical modulator 3 and impedance Zn of the dummy element unit 4 satisfy, for example, a relationship of 1≤(Zn/Zp)≤3.

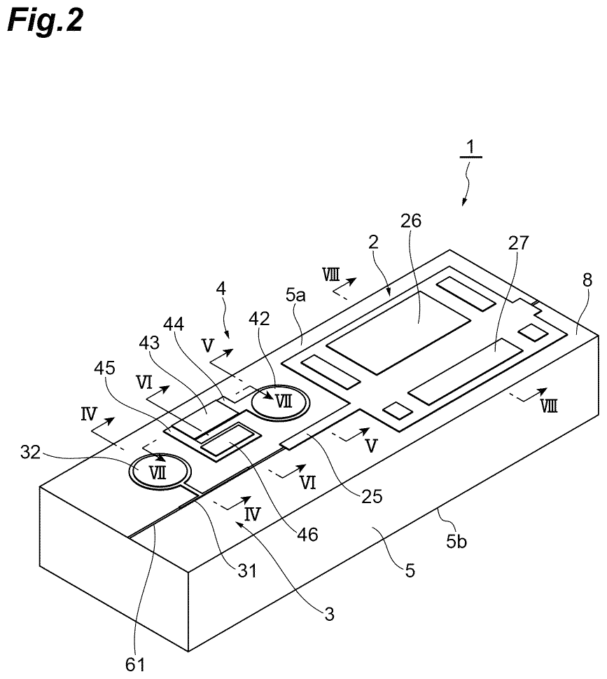

FIG. 2 is a perspective view illustrating an external appearance of the EML 1. As illustrated in FIG. 2, the EML 1 includes a semiconductor substrate 5. The semiconductor substrate 5 has a conductivity type, for example, an n-type. The laser unit 2, the optical modulator 3, and the dummy element unit 4 are provided on the same semiconductor substrate 5. A planar shape of the semiconductor substrate 5 is a rectangular shape that is long in an optical waveguide direction. The laser unit 2 and the optical modulator 3 are arranged along the optical waveguide direction. An optical waveguide 61 extends from a first end to a second end of the semiconductor substrate 5 in the optical waveguide direction. The laser unit 2 includes a portion close to a first end of the optical waveguide 61. The optical modulator 3 includes a portion close to a second end of the optical waveguide 61. The dummy element unit 4 is disposed between the laser unit 2 and the optical modulator 3.

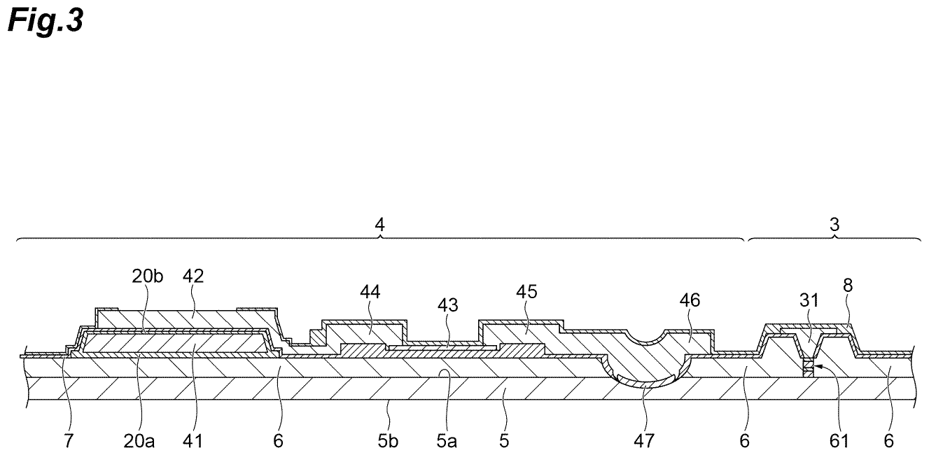

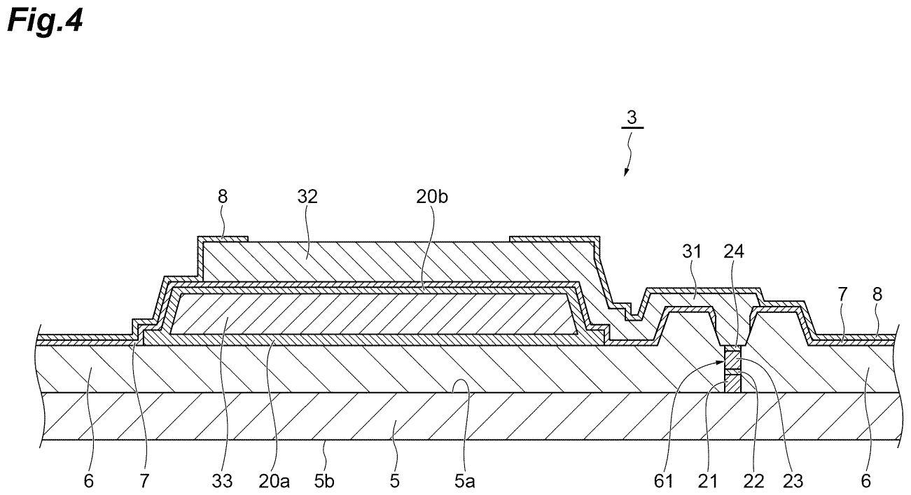

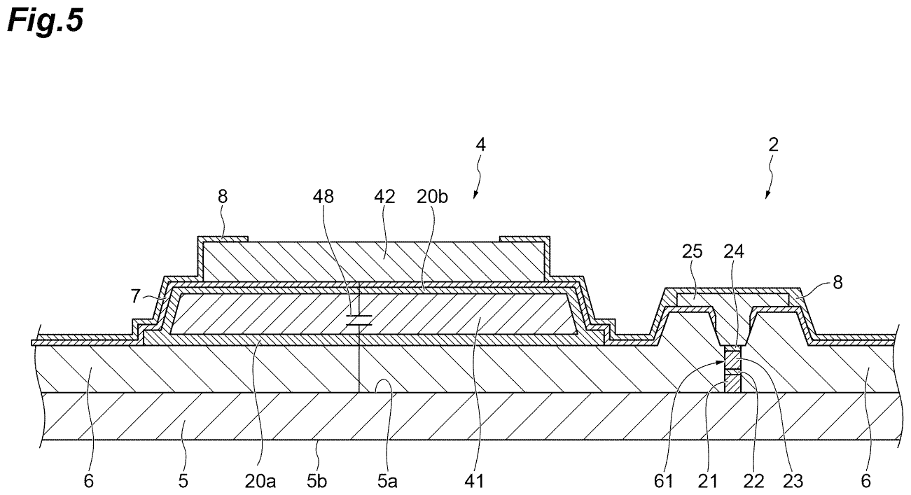

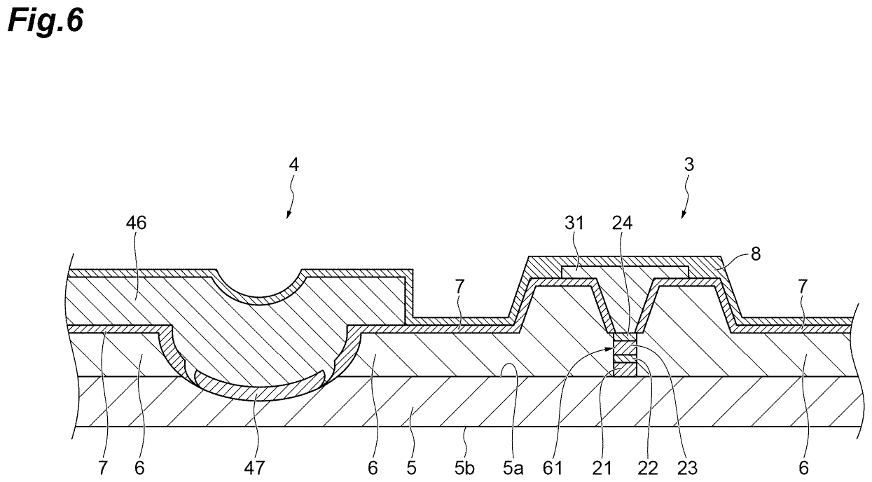

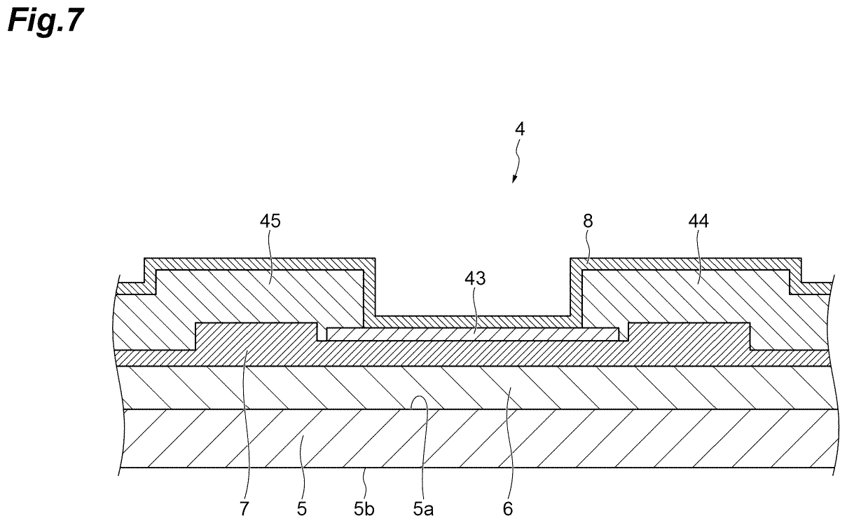

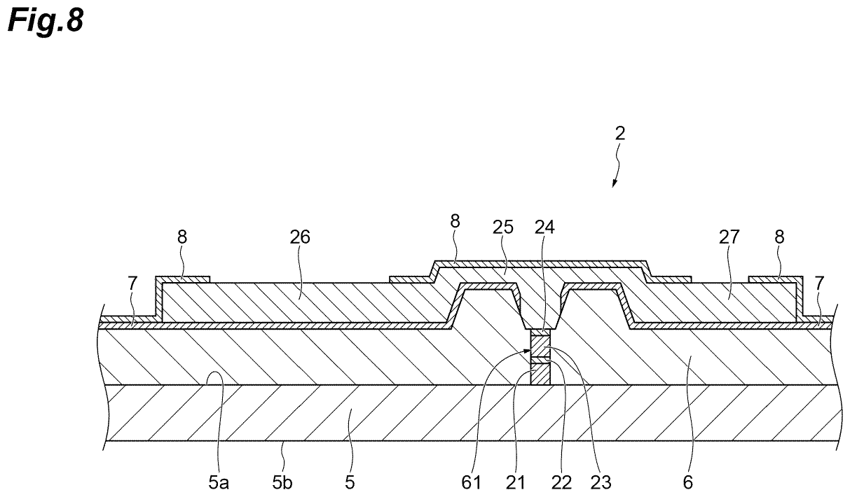

FIG. 3 shows a cross-section passing through the second signal pad 42, the resistor 43, an electrode 46, and a modulation electrode 31 shown in FIG. 2. FIG. 4 shows a cross-section along line IV-IV shown in FIG. 2, that is, a cross-section passing through the modulation electrode 31 and the first signal pad 32. FIG. 5 shows a cross-section along line V-V shown in FIG. 2, that is, a cross-section passing through the electrode 25 and the second signal pad 42. FIG. 6 shows a cross-section along line VI-VI shown in FIG. 2, that is, a cross-section passing through the electrode 46 and the modulation electrode 31. FIG. 7 shows a cross-section along line VII-VII shown in FIG. 2, that is, a cross-section passing through the resistor 43. FIG. 8 shows a cross-section along line VIII-VIII shown in FIG. 2, that is, a cross-section passing through the pad 26, the electrode 25, and the pad 27. Hereinafter, configurations of the laser unit 2, the optical modulator 3, and the dummy element unit 4 will be described with reference to FIG. 2 to FIG. 8.

As described above, the laser unit 2 includes a part of the optical waveguide 61. The optical waveguide 61 is provided on a main surface 5a of the semiconductor substrate 5, and includes a lower clad layer 21, an active layer 22, an upper clad layer 23, and a contact layer 24. The lower clad layer 21, the active layer 22, the upper clad layer 23, and the contact layer 24 are laminated in this order from the main surface 5a. The lower clad layer 21, the active layer 22, the upper clad layer 23, and the contact layer 24 have a mesa structure that is confined from both sides by a semi-insulating layer 6 provided on the main surface 5a. The lower clad layer 21, the active layer 22, the upper clad layer 23, and the contact layer 24 mainly contain, for example, an InP-based semiconductor.

The laser unit 2 further includes the electrode 25, the pad 26, and the pad 27. The electrode 25 includes a layer that is in ohmic contact with contact layer 24, and a wiring layer provided on the layer. The wiring layer is, for example, a gold (Au) layer. The electrode 25 is provided on an insulating film 7 provided on the semi-insulating layer 6, and is in contact with the contact layer 24 through an opening formed in the insulating film 7. An upper surface of the electrode 25 is covered with an insulating film 8. The insulating film 7 and the insulating film 8 contain, for example, a silicon compound such as SiO₂. The pad 26 and the pad 27 are provided on the insulating film 7 formed on the semi-insulating layer 6, and is provided on both sides of the electrode 25 in a direction intersecting the optical waveguide direction. The pad 26 and the pad 27 contain, for example, gold (Au). An upper surface of each of the pad 26 and the pad 27 is exposed through an opening formed in the insulating film 8.

In the laser unit 2, a bias current is supplied to the electrode 25 through the pad 26 or the pad 27. A rear electrode (not illustrated) set to a reference potential is provided on a rear surface 5b of the semiconductor substrate 5. When the bias current flows between the electrode 25 and the rear electrode, light is generated in the active layer 22. The light resonates in the optical waveguide 61 along the optical waveguide direction, becomes laser light, and is output to the optical modulator 3.

As described above, the optical modulator 3 includes another part of the optical waveguide 61. A configuration of the optical waveguide 61 in the optical modulator 3 is the same as a configuration of the optical waveguide 61 in the laser unit 2. The optical modulator 3 further includes the modulation electrode 31 (modulation electrode), the first signal pad 32, and a dielectric layer 33. The modulation electrode 31 includes a layer that is in ohmic contact with the contact layer 24, and a wiring layer formed on the layer. The wiring layer is, for example, a gold (Au) layer. The modulation electrode 31 is provided on the insulating film 7 formed on the semi-insulating layer 6, and is in contact with the contact layer 24 through an opening formed in the insulating film 7. An upper surface of the modulation electrode 31 is covered with the insulating film 8.

The first signal pad 32 is provided on the insulating film 7 formed on the semi-insulating layer 6, and is provided on one side of the modulation electrode 31 in a direction intersecting the optical waveguide direction. The first signal pad 32 contains, for example, gold (Au). An upper surface of the first signal pad 32 is exposed through an opening formed in the insulating film 8. The dielectric layer 33 is provided between the semi-insulating layer 6 and the first signal pad 32, and is covered with an insulating film 20a and an insulating film 20b. The insulating film 7 covers the insulating film 20a and the insulating film 20b. The dielectric layer 33 has a permittivity lower than that of the insulating film 7. A constituent material of the dielectric layer 33 is, for example, benzo-cyclo-butene (BCB). A structure in which the dielectric layer 33 and the semi-insulating layer 6 are disposed between the first signal pad 32 and the semiconductor substrate 5 functions as a capacitor.

In the optical modulator 3, a positive-phase signal among differential signals as a modulation signal is input to the first signal pad 32. According to this, the modulation signal is supplied to the modulation electrode 31 through the first signal pad 32. When the modulation signal is applied between the modulation electrode 31 and the rear electrode, laser light guided in the optical waveguide 61 is modulated. The modulated laser light is output to the outside of the EML 1.

The dummy element unit 4 is provided at a position spaced apart from the optical waveguide 61, and is not optically coupled to the laser unit 2. The dummy element unit 4 can adjust impedance with the optical modulator 3 to be close to impedance of the transmission lines through which the differential signals are transmitted. The dummy element unit 4 is an impedance adjustment circuit for compatibility between a band and reflection characteristics. An equivalent circuit that constitutes the dummy element unit 4 includes a capacitive component and a resistor that is connected to the capacitive component in parallel. The equivalent circuit that constitutes the dummy element unit 4 is an equivalent circuit that simulates an optical modulator. The resistor has a function of simulating a light absorption current flowing through a modulator. The capacitive component is a capacitor element having a configuration in which a dielectric substance is sandwiched between a pair of electrodes. The dummy element unit 4 includes a dielectric layer 41, the second signal pad 42, the resistor 43, a wiring 44, a wiring 45, and the electrode 46. The electrode 46 includes an ohmic metal layer 47 that is in an ohmic contact with the semiconductor substrate 5, and a wiring layer provided on the ohmic metal layer 47. The ohmic metal layer 47 is, for example, a TiW layer. The wiring layer is, for example, a gold (Au) layer. The electrode 46 is in contact with the semiconductor substrate 5 through openings formed in the semi-insulating layer 6 and the insulating film 7. An upper surface of the electrode 46 is covered with the insulating film 8. The electrode 46 draws the potential (reference potential) of the rear electrode up to the insulating film 7.

The second signal pad 42 is provided on the insulating film 7 formed on the semi-insulating layer 6, and is provided on one side of the optical waveguide 61 in a direction intersecting the optical waveguide direction. The second signal pad 42 contains, for example, gold (Au). An upper surface of the second signal pad 42 is exposed through the opening formed in the insulating film 8. The dielectric layer 41 is provided between the semi-insulating layer 6 and the second signal pad 42, and is covered with an insulating film 20a and an insulating film 20b. The insulating film 7 covers the insulating film 20a and the insulating film 20b. The dielectric layer 41 has a permittivity lower than that of the insulating film 7. A constituent material of the dielectric layer 41 is, for example, BCB. A structure in which he dielectric layer 41 and the semi-insulating layer 6 are disposed between the second signal pad 42 and the semiconductor substrate 5 functions as a capacitor 48.

The resistor 43 is a film resistor formed on the insulating film 7. The resistor 43 is, for example, a NiCrSi film. A first end of the resistor 43 is connected to the second signal pad 42 through the wiring 44. A second end of the resistor 43 is connected to the electrode 46 through the wiring 45. According to this, the resistor 43 is connected to the capacitor 48 in parallel, and is connected to the second signal pad 42. According to this, the wirings 44 and 45 contain, for example, gold (Au). As illustrated in FIG. 2, the resistor 43 is aligned with the second signal pad 42 in the optical waveguide direction. The resistor 43 is aligned with the electrode 46 in a direction intersecting the optical waveguide direction. An upper surface of the resistor 43 is covered with the insulating film 8.

In the dummy element unit 4, among differential signals as a modulation signal, a negative-phase signal is input to the second signal pad 42. According to this, the modulation signal is applied to the resistor 43 through the second signal pad 42.

FIG. 9 is a perspective view illustrating an optical modulation circuit 10 including the EML 1. FIG. 10 is a plan view illustrating the optical modulation circuit 10. As illustrated in FIG. 9 and FIG. 10, the optical modulation circuit 10 includes the EML 1, a carrier 11 having a main surface 11a, a capacitor 14, a capacitor 15, and a termination resistor 16. For example, the carrier 11 is formed from AlN. A signal line 121, a signal line 122, a ground pattern 123, and a pattern wiring 124 are provided on the main surface 11a of the carrier 11. The ground pattern 123 is set to a reference potential. The rear electrode of the EML 1 is conductively bonded to the ground pattern 123.

The pad 26 of the laser unit 2 is connected to a first electrode of the capacitor 14 by a bonding wire 131. A second electrode of the capacitor 14 is conductively joined to the ground pattern 123. The capacitor 14 functions as a by-pass capacitor. A bias voltage is applied to the pad 26 through the bonding wire 131.

The ground pattern 123 is disposed on both sides of the signal line 121, and a transmission line (coplanar line) is constituted by the signal line 121 and the ground pattern 123. A tip end portion of the signal line 121 is connected to the first signal pad 32 of the optical modulator 3 by a bonding wire 132. A positive-phase signal of differential signals is input to the first signal pad 32 through the signal line 121 and the bonding wire 132. The first signal pad 32 is further connected to a first electrode of the capacitor 15 through the bonding wire 133. A second electrode of the capacitor 15 is connected to the ground pattern 123 through the termination resistor 16.

The ground pattern 123 is disposed on both sides of the signal line 122, and a transmission line (coplanar line) is constituted by the signal line 122 and the ground pattern 123. A tip end portion of the signal line 122 is connected to the second signal pad 42 of the dummy element unit 4 by a bonding wire 134. A negative-phase signal of differential signals is input to the second signal pad 42 through the signal line 122 and the bonding wire 134.

Effects obtained by the EML 1 according to the embodiment described above will be described. In a single-phase driven EML in the related art, for example, when characteristic impedance of a transmission line is 50Ω, a termination resistance value is frequently set to 50Ω. However, when considering impedance of the EML (for example, 100Ω), load impedance ZL of the EML and a termination resistor which are combined becomes ZL=1/(1/100+1/50)=33Ω, which causes reflection of high-frequency signals. A reflection coefficient Γ is defined as Γ=(Zo−ZL)/(Zo+ZL) by using the characteristic impedance Zo of the transmission line and the load impedance ZL. The reflection coefficient Γ (ignoring a reactance component at low frequencies) of the single-phase driven EML in the related art is ZL=33Ω, and thus Γ becomes (50−33)/(50+33)=0.2.

With regard to this problem, for example, it is considered to set a termination resistance value to 100Ω. In this case, load impedance of the EML and the termination resistor which are combined becomes 50Ω, and the load impedance is equal to the characteristic impedance. Accordingly, reflection of high-frequency signals can be suppressed.

However, when the termination resistance value is increased, there is a problem that the band allowed for high frequency signals becomes narrower for the following reason. When combined resistance of output impedance of a driving circuit that drives the EML, the impedance of the EML, and the termination resistance is set as Ro, and combined capacitance of the capacitance of the EML and parasitic capacitance of a carrier is set as Co, a band fc is defined as fc=1/(2π×Co×Ro). When the characteristic impedance of the transmission line is set as Zo, the resistance value of the EML is set as Ract, and the termination resistance value is set as Rt, since 1/Ro=1/Zo+1/Ract+1/Rt, when the termination resistance value Rt is 50Ω, Ro=1/(1/50+1/100+1/50)=20Ω. Therefore, the band fc of the EML satisfies a relationship of fc=1/(2π×Co×20). In contrast, in a case where the termination resistance value Rt is 100Ω, Zo=1/(1/50+1/100+1/100)=25Ω, and thus the band fc of the EML satisfies a relationship of fc=1/(2π×Co×25). In this way, when the termination resistance value is doubled, the band fc of the EML becomes 0.8 times, and the band becomes narrower.

The EML 1 according to this embodiment includes the laser unit 2 that outputs laser light, the optical modulator 3 including the modulation electrode 31 to which one differential signal is input as a positive-phase signal, and the dummy element unit 4 to which the other differential signal is input as a negative-phase signal. The optical modulator 3 is connected between the one differential signal and a reference potential. The dummy element unit 4 is connected between the other differential signal and the reference potential, and includes a resistive component and a capacitive component connected in parallel. In the EML 1, the other differential signal (negative-phase signal) is input to the dummy element unit 4 through the second signal pad 42. According to this, load impedance of a circuit constituted by the optical modulator 3 to which the one differential signal (positive-phase signal) is input, and the termination resistor 16, and load impedance of the dummy element unit 4 to which the other differential signal (negative-phase signal) is input are combined, and thus the overall load impedance can be made to be close to characteristic impedance of a transmission line. Accordingly, reflection of high-frequency signals can be reduced. For example, when adjusting both the characteristic impedance Zo of the transmission line and the load impedance ZL to 100Ω, the reflection coefficient Γ becomes Γ=(100−100)/(100+100)=0.

In addition, the band of high-frequency signals can also be secured to have the same width as in the optical modulator in the related art. For example, when the termination resistance value Rt is set to 50Ω, Zo=1/(1/50+1/100+1/50)=20Ω, and fc=1/(2π×Co×20), and thus it is possible to secure the same band as in the single-phase driven EML in the related art. Accordingly, according to the EML 1 of this embodiment, it is possible to avoid narrowing of the band of the high-frequency signals while reducing reflection of the high-frequency signals. Accordingly, it is possible to improve trade-off between the reflection of the high-frequency signals and the securement of the band.

As in this embodiment, the capacitive component of the dummy element unit 4 may be the capacitor 48 having a configuration in which the dielectric layer 41 is sandwiched between a pair of electrodes. For example, according to this configuration, the capacitive component of the dummy element unit 4 can be obtained.

As in this embodiment, an electrode (rear electrode) on a side opposite to the modulation electrode 31 of the optical modulator 3, and an end on a side opposite to an end connected to the second signal pad 42 of the dummy element unit 4, that is, the electrode 46 may be set to a reference potential. Even in this case, it is possible to avoid narrowing of the band of the high-frequency signals while reducing reflection of the high-frequency signals.

As in this embodiment, the end on a side opposite to the end connected to the second signal pad 42 of the dummy element unit 4, that is, the electrode 46 may be connected to an electrode (rear electrode) on a side opposite to the modulation electrode 31 of the optical modulator 3. Even in this case, it is possible to avoid narrowing of the band of the high-frequency signals while reducing reflection of the high-frequency signals.

As in this embodiment, the laser unit 2, the optical modulator 3, and the dummy element unit 4 may be provided on the same semiconductor substrate 5. This case contributes to reduction in size of the EML 1. In addition, since the dummy element unit 4 and the optical modulator 3 are provided on the same semiconductor substrate 5, the following effects are obtained.

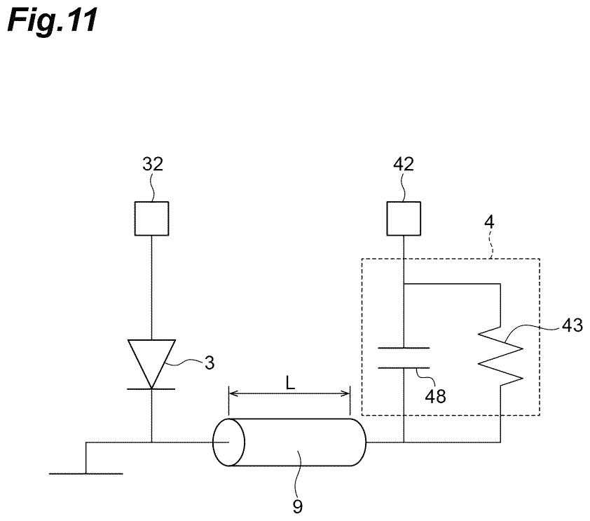

FIG. 11 illustrates a circuit diagram when the dummy element unit 4 is provided away from the semiconductor substrate 5 as a comparative example. As shown in the same drawing, in this case, the end on a side opposite to the end connected to the second signal pad 42 of the dummy element unit 4 is spaced apart from the electrode (rear electrode) on a side opposite to the modulation electrode 31 of the optical modulator 3. Therefore, a distance L of a wiring 9 (for example, a part of the ground pattern 123) therebetween is lengthened, and thus it cannot be regarded to have the same potential. Even in the same potential, when the distance Lis lengthened, since a portion that is not a differential line may occur, cross-talk occurs in a degree corresponding to the distance. In addition, when the distance Lis lengthened, the effect of reducing reflection of high-frequency signals is reduced.

However, when the distance L is within a certain range, the above-described problem hardly occurs. That is, the distance L may be sufficiently shorter than a wavelength of a modulation signal. In an example, the distance L may be at least 1/20 times the wavelength as a distance L at which the wavelength of the modulation signal can be ignored, that is, a distance that can be handled by a lumped constant circuit. For example, in a case where effective permittivity ε_{eff} is 9, and a signal frequency of a modulation signal is 100 GHz, since the wavelength of the modulation signal is 1 mm, the distance L may be set to be equal to or less than 50 μm that is 1/20 times the wavelength. For example, in 112 GBaud PAM4 transmission, in a case where a coplanar line is provided on the carrier 11 formed from AlN on which the EML1 is mounted, the effective permittivity ε_{eff} is approximately 6. Since a nyquist frequency of the 112 GBaud PAM4 is 56 GHZ, an allowable distance Lis 110 μm. Therefore, the distance L is substantially smaller than a chip size of the EML1. For this reason, it is desirable to provide the dummy element unit 4 inside a chip, that is, on the semiconductor substrate 5.

In addition to satisfying the above-described condition for the distance L, it is preferable that impedance of the wiring 9 is sufficiently low. Qualitatively, it is preferable that the impedance of the wiring 9 is a magnitude at which modulation in the optical modulator 3 can be ignored when a modulation signal is input to the dummy element unit 4. The impedance of the wiring 9 is, for example, 2Ω or less.

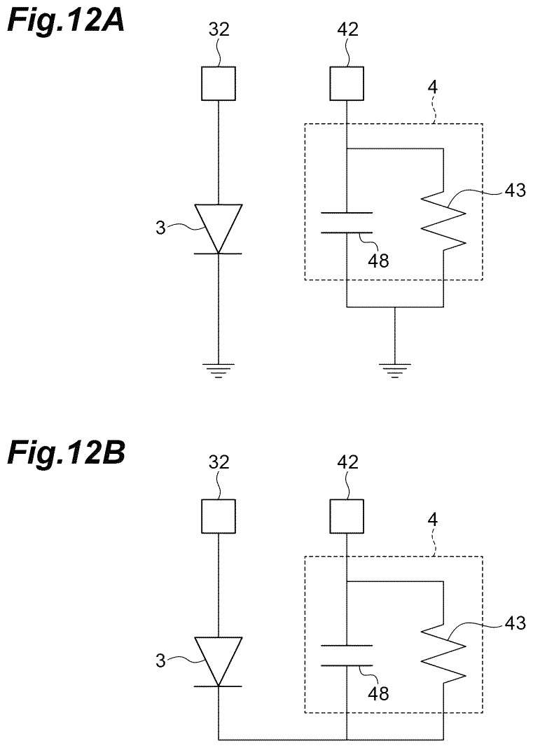

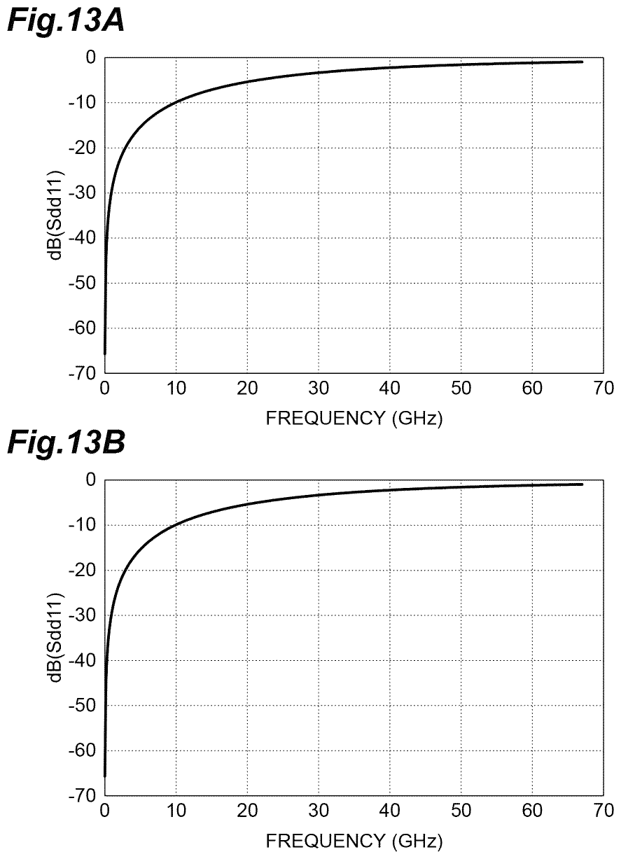

Here, FIG. 12A shows a circuit diagram when both the electrode on a side opposite to the modulation electrode 31 of the optical modulator 3 and the end on a side opposite to the end connected to the second signal pad 42 of the dummy element unit 4 are individually connected to a reference potential line. FIG. 12B shows a circuit diagram when both the electrode on a side opposite to the modulation electrode 31 of the optical modulator 3 and the end on a side opposite to the end connected to the second signal pad 42 of the dummy element unit 4 are connected to each other and are floating. When the impedance Zn of the dummy element unit 4 is equal to the impedance Zp of the optical modulator 3, magnitudes of reflection of the high-frequency signals when viewed from an input side are equal to each other. For example, when capacitance of each of the optical modulator 3 and the capacitor 48 is 0.2 pF and the termination resistor 16 and the resistor 43 are 50Ω, an S parameter indicating the magnitude of reflection of the high-frequency signal, that is, Sdd11, is −30.1 dB at 1 GHz in both cases. The reflection coefficient Γ is 0.03 in both cases. FIG. 13A is a graph showing a relationship between a frequency (GHz) and the Sdd11 in the circuit shown in FIG. 12A. FIG. 13B is a graph showing a relationship between a frequency (GHz) and the Sdd11 in the circuit shown in FIG. 12B.

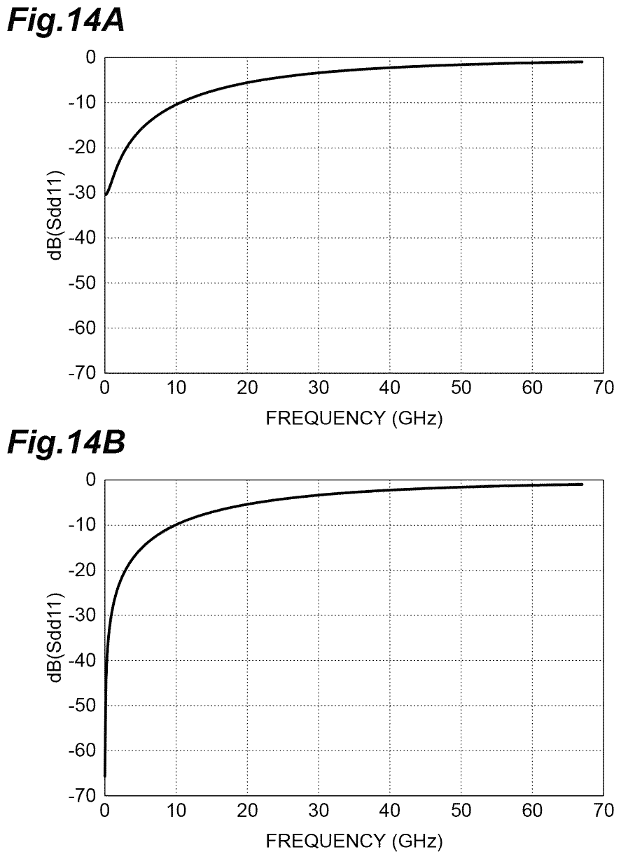

Even in a case where the impedance Zn of the dummy element unit 4 is different from the impedance Zp of the optical modulator 3, the magnitudes of the reflection of the high-frequency signals are almost equal to each other. For example, when the capacitance of each of the optical modulator 3 and the capacitor 48 is 0.2 pF, the termination resistor 16 is 33Ω, and the resistor 43 is 67Ω, the S parameter (Sdd11) indicating the magnitude of the reflection of the high frequency signal is 27.3 dB in the case of the circuit shown in FIG. 12A, and 29.1 dB in the case of the circuit shown in FIG. 12B. The reflection coefficient Γ is 0.04 in both cases. FIG. 14A is a graph showing a relationship between a frequency (GHz) and the Sdd11 in the circuit shown in FIG. 12A. FIG. 14B is a graph showing a relationship between a frequency (GHz) and the Sdd11 in the circuit shown in FIG. 12B.

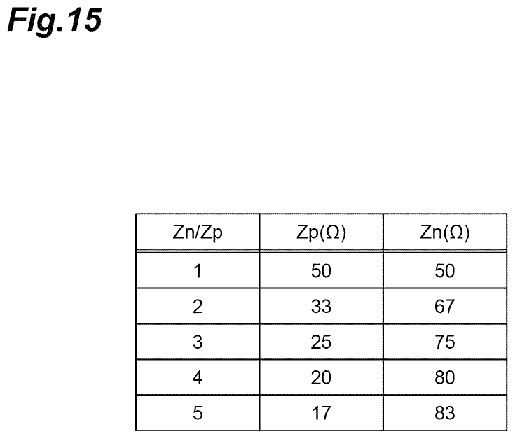

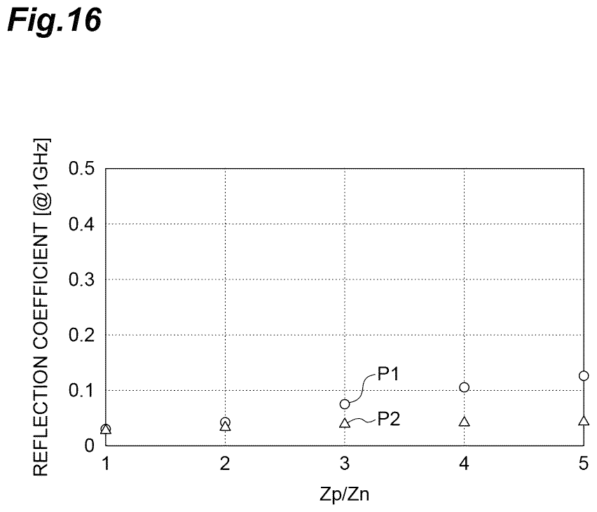

FIG. 15 is a table showing an example of a combination of the impedance Zp of the optical modulator 3 and the impedance Zn of the dummy element unit 4. FIG. 16 is a graph showing a relationship between a ratio (Zp/Zn) and the reflection coefficient Γ at 1 GHz. In FIG. 16, a plot P1 shows a value in the circuit shown in FIG. 12A, and a plot P2 shows a value in the circuit shown in FIG. 12B. As shown in FIG. 16, in the circuit shown in FIG. 12A, when the ratio (Zp/Zn) satisfies a relationship of 1≤(Zn/Zp)≤3, the reflection coefficient Γ is less than 0.1 and is sufficiently reduced. In the circuit shown in FIG. 12B, the reflection coefficient Γ is less than 0.1 and is sufficiently reduced regardless of the ratio (Zp/Zn). From this, in a case of the circuit shown in FIG. 12A, that is, in a case where both the electrode on a side opposite to the modulation electrode 31 of the optical modulator 3 and the end on a side opposite to the end connected to the second signal pad 42 of the dummy element unit 4 are individually connected to the reference potential line, it is preferable that the ratio (Zp/Zn) satisfies a relationship of 1≤(Zn/Zp)≤3. According to this, it is possible to further reduce the reflection of high-frequency signals.

In the configuration example illustrated in FIG. 2 to FIG. 10, the end on a side opposite to the end connected to the second signal pad 42 of the dummy element unit 4 is connected to the opposite side of the modulation electrode 31 of the optical modulator 3 through the rear electrode. Since the rear electrode is connected to an absolute reference potential provided outside the optical modulation circuit 10 through the ground pattern 123, slight impedance exists between the rear electrode and the absolute reference potential. Therefore, it can be said that an actual configuration is close to the circuit configuration shown in FIG. 12B.

### [Modification]

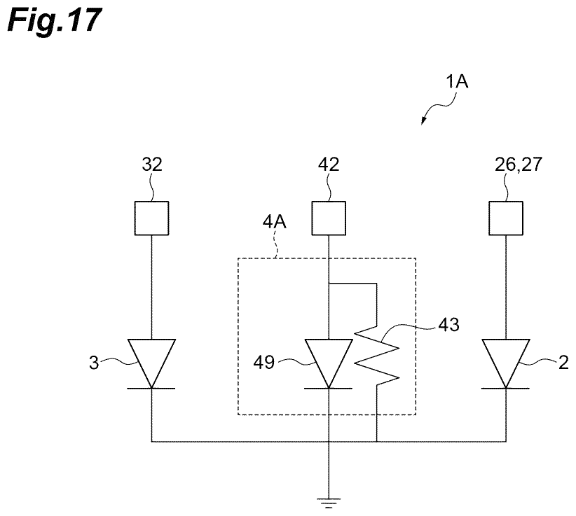

FIG. 17 is a circuit diagram illustrating a configuration of EML 1A as a modification of the above-described embodiment. The EML 1A of this modification is different from the above-described embodiment in a configuration of a dummy element unit, and is the same as the above-described embodiment in other configurations. The EML 1A of this modification includes a dummy element unit 4A instead of the dummy element unit 4 of the above-described embodiment. The dummy element unit 4A includes a dummy optical modulator 49 instead of the capacitor 48. A capacitive component of the dummy optical modulator 49 is a dummy region including a region having the same semiconductor lamination structure as in the optical modulator connected to both ends of the capacitive component, and is not optically coupled to the laser unit 2. A modulation electrode having the same configuration as the modulation electrode 31, that is, a dummy modulation electrode is in contact with the dummy optical modulator 49. The modulation electrode is connected to the second signal pad 42. As a result, the dummy optical modulator 49 receives a signal with a phase opposite to that of a modulation signal. The dummy optical modulator 49 functions as a reverse-biased diode, and simulates the optical modulator 3 with a resistor 43 connected to the dummy optical modulator 49 in parallel. In this manner, the capacitive component of the dummy element unit 4A may include a region having the same semiconductor lamination structure as in the optical modulator 3 connected to both ends of the capacitive component. For example, with such a configuration, the capacitive component of the dummy element unit 4A can be obtained.

The optical modulator integrated laser element, the optical modulation circuit, and the optical modulator according to the present disclosure are not limited to the above-described embodiment, and various other modifications can be made. For example, in the embodiment and the modification described above, a dummy element unit includes a resistor and a capacitor connected in parallel with each other, and the dummy element unit has an optical modulator that does not modulate laser light. The configuration of the dummy element unit is not limited thereto, and various configurations is applicable as long as simulation of characteristics of the optical modulator is possible.

In the embodiment and the modification described above, an EML including a laser unit and an optical modulator has been exemplified. However, the present disclosure is not limited to this embodiment, and a semiconductor laser element and an optical modulator may be provided separately. In this case, the semiconductor laser element may have the same configuration as that of the laser unit, and the optical modulator may have the same configuration as that of the optical modulator in the embodiment or the modification.

What is claimed is:

1. An optical modulator integrated laser element, comprising:
a laser unit configured to output laser light;
an optical modulator including a modulation electrode to which one differential signal is input as a positive-phase signal; and
a dummy element unit to which another differential signal is input as a negative-phase signal,
wherein the optical modulator is connected between the one differential signal and a reference potential, and
the dummy element unit is connected between the another differential signal and the reference potential, and includes a resistive component and a capacitive component connected in parallel.

2. The optical modulator integrated laser element according to claim 1,
wherein the capacitive component of the dummy element unit is a capacitor element having a configuration in which a dielectric substance is sandwiched between a pair of electrodes.

3. The optical modulator integrated laser element according to claim 1,
wherein the capacitive component of the dummy element unit includes a region having a same semiconductor lamination structure as the optical modulator connected to both ends of the capacitive component.

4. The optical modulator integrated laser element according to claim 1,
wherein impedance Zp of the optical modulator and impedance Zn of the dummy element unit satisfy a relationship of 1≤(Zn/Zp)≤3.

5. An optical modulation circuit, comprising:
a pair of transmission lines through which differential signals are transmitted;
an optical modulator to which one differential signal of the differential signals is input as a positive-phase signal; and
a dummy element unit to which another differential signal of the differential signals is input as a negative-phase signal,
wherein the optical modulator is connected between one of the transmission lines and a reference potential, and
the dummy element unit is connected between the another differential signal and the reference potential, and includes a resistive component and a capacitive component connected in parallel.

6. The optical modulation circuit according to claim 5,
wherein the capacitive component of the dummy element unit is a capacitor element having a configuration in which a dielectric substance is sandwiched between a pair of electrodes.

7. The optical modulation circuit according to claim 5,
wherein the capacitive component of the dummy element unit includes a region having a same semiconductor lamination structure as the optical modulator connected to both ends of the capacitive component.

8. The optical modulation circuit according to claim 5,
wherein impedance Zp of the optical modulator and impedance Zn of the dummy element unit satisfy a relationship of 1≤(Zn/Zp)≤3.

9. An optical modulator, comprising:
an optical modulator including a modulation electrode to which one differential signal is input as a positive-phase signal; and
a dummy element unit to which another differential signal is input as a negative-phase signal,
wherein the optical modulator is connected between the one differential signal and a reference potential, and
the dummy element unit is connected between the another differential signal and the reference potential, and includes a resistive component and a capacitive component connected in parallel.

10. The optical modulator according to claim 9,
wherein the capacitive component of the dummy element unit is a capacitor element having a configuration in which a dielectric substance is sandwiched between a pair of electrodes.

11. The optical modulator according to claim 9,
wherein the capacitive component of the dummy element unit includes a region having a same semiconductor lamination structure as the optical modulator connected to both ends of the capacitive component.

12. The optical modulator according to claim 9,
wherein impedance Zp of the optical modulator and impedance Zn of the dummy element unit satisfy a relationship of 1≤(Zn/Zp)≤3.
